(19) United States
(12) Patent Application Publication
(10) Pub. No.: US 2022/0382355 A1
(43) Pub. Date: Dec. 1, 2022

(54) SYSTEM ON A CHIP

(71) Applicant: STMicroelectronics S.r.l., Agrate Brianza (MB) (IT)

(72) Inventors: Antonino MONDELLO, Messina (IT); Alessandro INGLESE, San Pietro Clarenza (CT) (IT)

(73) Assignee: STMicroelectronics S.r.l., Agrate Brianza (MB) (IT)

(21) Appl. No.: 17/752,229

(22) Filed: May 24, 2022

(30) Foreign Application Priority Data
May 31, 2021 (FR) 2105674

(51) Int. Cl. G06F 1/3206; G06F 15/78

(52) U.S. Cl. CPC G06F 1/3206; G06F 15/7807; G06F 2213/0038

(57) ABSTRACT

A system on chip includes a monitoring circuit that detects an anomalous behavior of the system on chip. The monitoring circuit compares a behavior of the system on chip to at least one reference parameter representing the anomalous behavior of the system. Using this comparison, the anomalous behavior of the system on chip is detected. An interrupt is the issued in response to the detected anomalous behavior of the system on chip.

### PRIORITY CLAIM

This application claims the priority benefit of French Application for Patent No. 2105674, filed on May 31, 2021, the content of which is hereby incorporated by reference in its entirety to the maximum extent allowable by law.

### TECHNICAL FIELD

Embodiments of the present disclosure refer to a system on a chip and, more particularly, to a system on chip secure against attempted intrusions by an unauthorized external user.

### BACKGROUND

A system on chip (SoC) is an integrated electronic system capable of performing a plurality of functions. A system on chip is used, for example, inside an electronic device such as a microcontroller.

It may occur that unauthorized external users try to access the electronic device that includes the system on chip in order to take control thereof and access the data stored therein.

For example, such unauthorized external users may try to access the system on chip through multiple and repeated uses of peripherals of the system on chip or by injecting noise signals or glitches, for example into the power supply voltage of the system on chip. Unauthorized external users can also perform battery removal attacks on the system on chip. These attacks are able to modify the behavior of the system on chip.

By modifying the behavior of the system on chip, the unauthorized external user can provoke an error in a processing core or in a memory area of the system on chip itself, with the aim of preventing its operation and/or trying to access it.

The problem therefore arises of providing an architecture of a system on chip robust against such attacks on the behavior of the system on chip.

### SUMMARY

According to an aspect, a system on a chip comprises: a monitoring circuit configured to detect an anomalous behavior of the system on chip. The monitoring circuit is configured to: compare the behavior of the system on chip to at least one reference parameter representing an anomalous behavior of the system in order to detect an anomalous behavior of the system on chip, and generate an interrupt when an anomalous behavior of the system on chip is detected.

By monitoring the behavior of the system on chip, such system on chip is configured to detect an attempted attack on the system on chip by an unauthorized external user.

When the monitoring circuit detects an attempted attack, the monitoring circuit generates an interrupt signal. This interrupt signal can be transmitted to a master circuit of the system on chip so as to execute an appropriate countermeasure to block the attack.

The countermeasures can include adding delay, disabling peripherals of the system on chip, and/or disabling features of the system on chip. Another countermeasure can also be requesting an authentication procedure to authorize the user to continue to use the system on chip and/or to reenable disabled peripherals/features.

This allows the security level of the system on chip to be increased and consequently, for example, the level of protection of the data stored there in and in an electronic device in which the system on chip can be incorporated.

Advantageously, the monitoring circuit is configured to monitor at least one type of event on the system on chip, the monitoring circuit comprising, for each type of event to monitor, a counter configured to count the number of events of said type of event during a period defined by a timer of the system on chip, and to detect an anomalous behavior of the system on chip when the number of the events reaches a number defined by the reference parameter representing an anomalous behavior of the system on chip.

According to a particularly advantageous embodiment, said at least one reference parameter is stored in a non-volatile register.

Preferably, the system on chip comprises: at least one peripheral, and the monitoring circuit being configured to monitor a usage frequency of said at least one peripheral and to detect an anomalous behavior of the system on chip when the usage frequency of said at least one peripheral reaches a maximum usage frequency value defined by said at least one reference parameter.

According to a particularly advantageous embodiment, the monitoring circuit is configured to disable said at least one peripheral when the monitoring circuit detects an anomalous behavior of the system on chip.

Advantageously, the monitoring circuit is configured to monitor reset cycle frequency of the system on chip and to detect an anomalous behavior of the system on chip when the reset cycle frequency reaches a maximum reset cycle frequency value defined by said at least one reference parameter.

According to a particularly advantageous embodiment, the monitoring circuit is configured to monitor a supply voltage spike frequency and to detect an anomalous behavior of the system on chip when the spike frequency reaches a maximum spike frequency value defined by said at least one reference parameter.

According to a particularly advantageous embodiment, the monitoring circuit is configured to monitor an Input/Output signal glitch frequency and to detect an anomalous behavior of the system on chip when the Input/Output signal glitch frequency reaches a maximum glitch frequency value defined by said at least one reference parameter.

According to a particularly advantageous embodiment, the monitoring circuit is configured to detect a removal of a battery of the system on chip.

### BRIEF DESCRIPTION OF THE DRAWINGS

Other advantages and features of the invention will appear in the detailed description of embodiments and implementations, in no way restrictive, and the attached drawings in which:

FIG. 1 shows a block diagram of a system on a chip;

FIG. 2 shows an example of a non-volatile configuration register;

FIG. 3 shows a block diagram for a monitoring circuit of the system on chip;

FIG. 4 illustrates a block diagram of a noise detector;

FIG. 5 illustrates a block diagram for a event counter unit of the monitoring circuit; and

FIG. 6 shows a block diagram of a peripheral management decoder.

### DETAILED DESCRIPTION

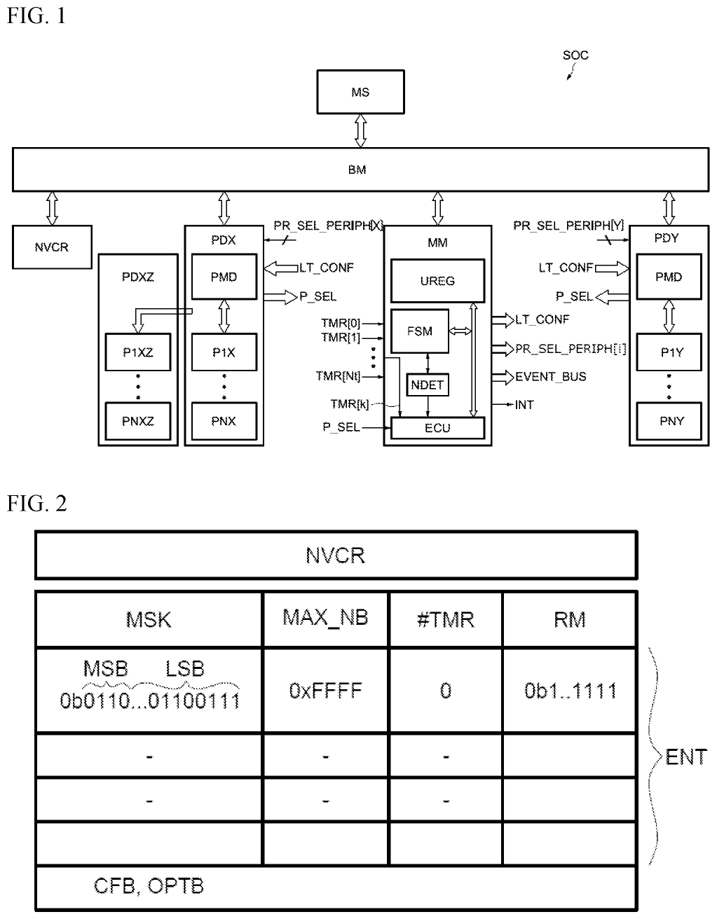

FIG. 1 shows a system on a system on a chip SOC comprising a master MS, a bus matrix BM, peripherals P1X, . . . , PNX, P1XZ, . . . , PNXZ, P1Y, . . . , PNY, a non-volatile configuration register NVCR and a monitoring circuit MM.

The master MS is a processing core of the system on chip. The system on chip can have more than one master MS.

The bus matrix BM connects the master MS to the peripherals. The bus matrix BM also connects the master MS to the non-volatile configuration register NVCR and to the monitoring circuit MM.

The peripherals are arranged in different peripheral domains. For example, the peripheral domain PDX includes peripherals P1X, . . . , PNX and a sub-domain PDXZ including peripherals P1XZ, . . . , PNXZ. The peripheral domain PDY includes peripherals P1Y, . . . , PNY.

Each peripheral domain comprises a peripheral management decoder PMD.

The monitoring circuit MM is configured to monitor the behavior of the system on chip.

In particular, the monitoring circuit MM is configured to monitor specified events, the events being defined as at least one of the group comprising a usage frequency of a peripheral or a group of peripherals, a reset frequency of the system on chip SOC, a spike frequency (or noise spike frequency) on the supply voltage signal, a glitch frequency on some Input/Output lines, and a removal of a battery of the system on chip SOC.

Such monitoring allows the monitoring circuit MM to detect an anomalous behavior of the system on chip SOC.

To ensure its security, the monitoring circuit MM can be placed in a trusted-zone and/or privileged zone of the system on chip SOC. It is also possible to use any other security hardware or software mechanism to secure the monitoring circuit MM.

The monitoring circuit MM is described in more detail below.

The monitoring circuit MM is connected to the non-volatile configuration register NVCR via the bus matrix BM.

The non-volatile configuration register NVCR can be implemented in a flash memory or in a one-time programmable memory.

The non-volatile configuration register NVCR can be protected by usual methods.

The non-volatile configuration register NVCR is configured to store parameters, also called reference parameters, for monitoring the behavior of the system on chip SOC by the monitoring circuit MM.

In particular, the non-volatile configuration register NVCR is configured to store these parameters in a table. The parameters in the table can be defined by the user of the system on chip.

Some parameters are comparison values that can be used for detecting an anomalous behavior of the system on chip.

The values stored in the non-volatile configuration register NVCR can only be defined by an authorized user.

More particularly, as parameters for the monitoring of the system on chip, the user can define a maximum usage frequency of a peripheral or a group of peripherals. Monitoring the usage frequency of a peripheral allows detection of brute force attacks and service exhaustion attacks against this peripheral.

The user can also define a maximum reset frequency of the system on chip. Monitoring the reset frequency of the system on chip allows detection of brute force attacks on the system on chip.

The user can also define a maximum spike frequency on the supply voltage signal Vdd. Monitoring the spike frequency on the supply voltage signal allows detection of an attempt to cause a failure of some internal registers of the system on chip, or an attempt to break some features of the system on chip, or an attempt to obfuscate a key usage.

The user can also define a maximum glitch frequency on some Input/Output signals or on a reset signal of the system on chip. Monitoring the glitch frequency on Input/Output signals or on the reset signal allows detection of an attempt to obfuscate key usage or an attempt to flip the volatile register content.

The user can also define a checking parameter to detect a battery removal.

The user can also define for which run modes of the peripheral or the group of peripherals these parameters apply. The run modes can be privileged, un-privileged, secure, etc., as defined by the processor core that is used and/or by the architecture of the system on chip.

Indeed, it can be not useful to monitor every run mode of the peripherals.

FIG. 2 shows an example of a non-volatile configuration register NVCR.

More particularly, the register can comprise a plurality of entries ENT for which are associated parameters for the monitoring of the behavior of the system on chip. Each entry of the table defines a bitword MSK. The bitword MSK is used to define the application for the parameters. More specifically, the bitword MSK defines whether the parameters are for monitoring the usage frequency of the peripherals, the reset frequency, the spike frequency on the supply voltage signal, the glitch frequency of Input/Output signals, or for the monitoring of a battery removal.

The bitword MSK of an entry can comprise four most significant bits MSB used to indicate the peripheral domain to which the parameters are referring, to indicate that the parameters are for monitoring the noise/spikes or glitches, the resets or a battery removal.

These bits MSB can also be used to deactivate some entries or to indicate that an entry is available. For example, the bits MSB can be equal to “0000” to deactivate an entry. In this case, the user can easily erase one or more entries in the table by programing all the bits of an entry to zero. Likewise, the bits MSB can be equal to “1111” to indicate that the entry is available.

The bitword MSK of an entry can also comprise 32 least significant bits LSB to specify the peripherals of the peripheral domain for which the same parameters apply.

A first parameter is a maximum number MAX_NB of occurrences of the monitored event (usage of peripherals, usage of resets, number of spikes on the supply voltage signal, number of glitches on Input/Output lines). This maximum number MAX_NB of usages indicates an anomalous behavior of the system on chip when it is reached.

A second parameter specifies a timer #TMR used to define a maximal duration to reach the maximum number of usages as defined above.

A third parameter RM specifies for which run mode (unprivileged, privileged, secure, non-secure, etc.) of the entry the monitoring has to be performed.

The non-volatile configuration register NVCR can also store some configuration bits CFB or option bits OPTB.

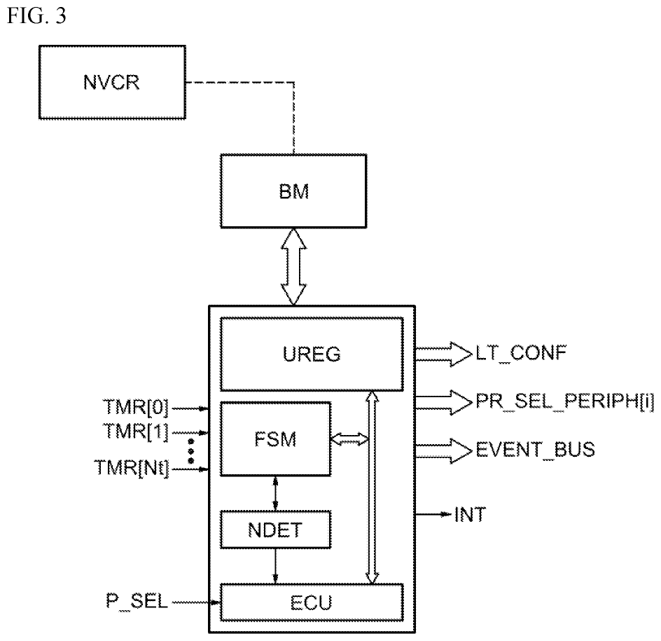

FIG. 3 shows the monitoring circuit MM of the system on chip SOC. The monitoring circuit MM includes a finite state machine FSM, an event counter unit ECU, a noise detector NDET, and user registers UREG.

The monitoring circuit MM is connected to a plurality of timers TMR[0], TMR[1], . . . , TMR[Nt]. The monitoring circuit MM can use these timers to monitor a usage frequency of the peripherals, the reset frequency, the noise/spike frequency on the supply voltage signal, or the glitch frequency on Input/Output lines.

The monitoring circuit is configured to select the timer TMR[k] to use for such monitoring between timers TMR[0], TMR[1], . . . , TMR[Nt] according to the timer #TMR indicated in the non-volatile configuration register.

To ensure their security, the timers can be placed in a trusted-zone and/or privileged zone of the system on chip SOC. It is also possible to use any other security hardware or software mechanism to secure the timers.

The monitoring circuit MM is also configured to deliver signals PR_SEL_PERIPH[i]. Signals PR_SEL_PERIPH[i] are used to manage a peripheral and/or a group of peripherals inside a same peripheral domain. In particular, signals PR_SEL_PERIPH[i] are used to enable or disable the peripherals and/or a group of peripherals. Signals PR_SEL_PERIPH[i] are delivered to the peripherals and/or to groups of peripherals. For example, on FIG. 1, signal PR_SEL_PERIPH[X] is delivered to the peripheral domain PDX, and signal PR_SEL_PERIPH[Y] is delivered to the peripheral domain PDY.

The monitoring circuit MM is also configured to deliver a signal LT_CONF. The signal LT_CONF is used to configure a look-up table in the peripheral management decoder PMD of a peripheral domain. This peripheral management decoder will be disclosed in more detail below.

The monitoring circuit MM is also configured to deliver an interrupt INT. The interrupt INT is raised when the peripheral monitoring detects an anomalous behavior of the system on chip. More particularly, the system on chip is configured to deliver the interrupt INT through an interrupt line connected to the processing core in a secure manner to avoid masking the interrupt so as to prevent feature disabling.

The monitoring circuit MM is also configured to deliver a signal EVENT_BUS. The signal EVENT_BUS is used to report the code of the anomalous behavior detected.

More particularly, the finite state machine FSM is configured to monitor the behavior of the system on chip according to the parameters defined in the non-volatile configuration register NVCR so as to be able to detect an anomalous behavior of the system on chip.

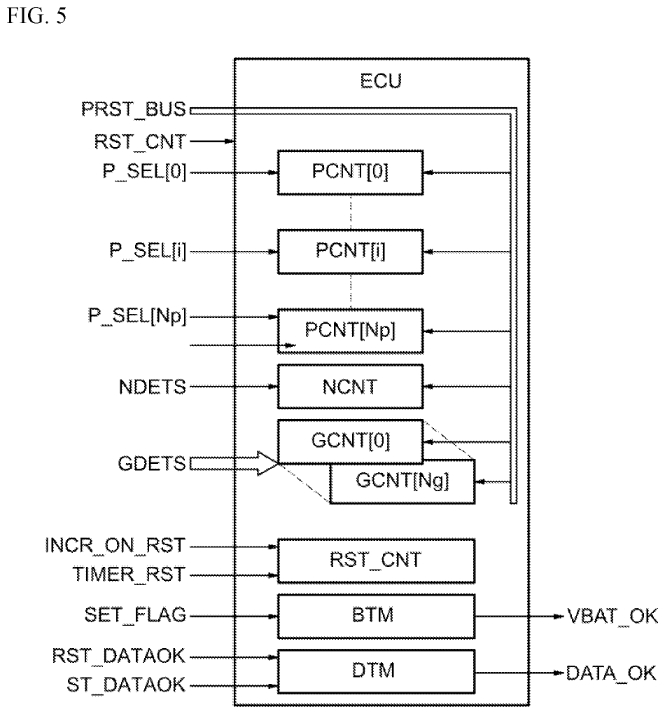

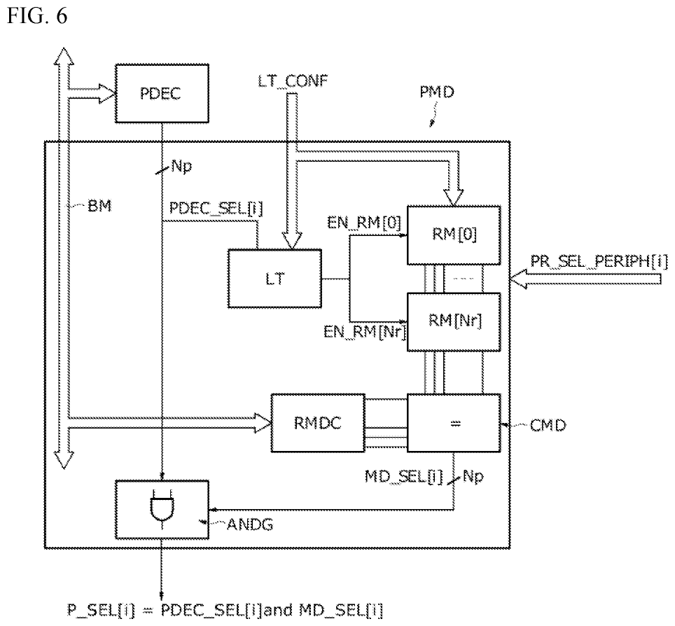

The event counter unit ECU comprises a plurality of counters configured to count the number of events in said maximal duration (peripheral usages, the reset number, the spike number on the supply voltage signal, or the glitch number on Input/Output lines), The event counter unit ECU is described in more detail below in relation with FIG. 5.

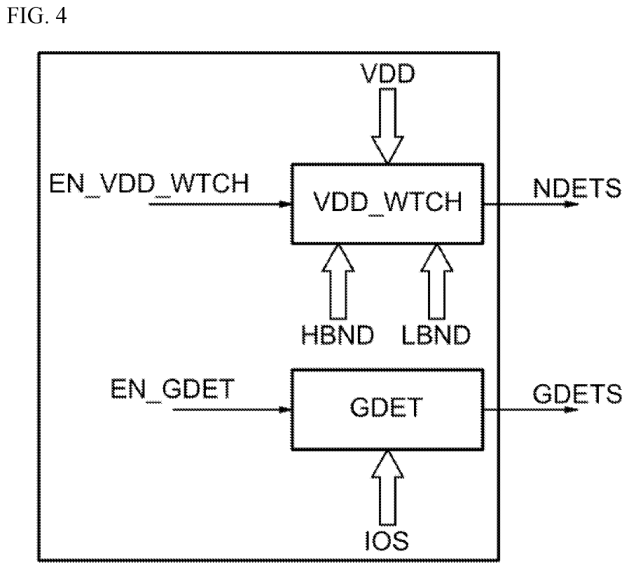

The noise detector NDET is configured to detect spikes on the supply voltage signal or glitches on Input/Output lines and will be described in more detail in relation with FIG. 4.

The user registers UREG allow the user of the system on chip to configure the monitoring circuit MM and are configured to receive commands from a master of the system on chip. The finite state machine FSM is connected to the user registers UREG.

Once the commands are written in the user registers UREG, the final state machine can automatically interpret these commands at the end of a bus cycle. The commands can be used to initialize or to read the different elements of event counter unit ECU.

FIG. 4 illustrates the noise detector NDET.

The noise detector NDET comprises a Vdd detector watchdog VDD_WTCH configured to detect spikes in the supply voltage signal and at least one glitch detector GDET configured to detect a glitch in the Input/Output lines.

The Vdd detector watchdog VDD_WTCH is configured to receive an enable signal EN_VDD_WTCH, the supply voltage signal VDD, a minimum bound LBND, and a maximum bound HBND. The Vdd detector watchdog is configured to detect a spike or a noise in the supply voltage signal VDD when the voltage of the supply voltage signal is above the maximum bound HBND or below the minimum bound LBND. The Vdd detector watchdog is further configured to deliver a signal NDETS when a spike or noise on the supply voltage signal is detected.

The glitch detector GDET is configured to receive an enable signal EN_GDET used to enable the glitch detector GDET and a signal IOS of the Input/Output lines and is configured to detect a glitch in the Input/Output lines when the signal in the Input/Output lines presents rapid variations. The glitch detector GDET is configured to deliver a signal GDETS when a glitch is detected in the Input/Output lines.

As a variant, a glitch detector GDET can be configured to receive a reset signal of the system on chip. In this case, the glitch detector GDET is configured to detect a glitch in the reset signal when the reset signal presents rapid variation.

FIG. 5 illustrates the event counter unit ECU of the monitoring circuit MM.

The event counter unit ECU is in a persistent domain, meaning that the event counter unit ECU is supplied by the battery voltage supply VBAT. The battery voltage supply is provided by an external battery. Thus, the data of the event counter unit ECU are not lost in case of a reset of the system on chip. Only the monitoring circuit MM is configured to reset the event counter unit ECU when needed. The event counter unit ECU comprises at least one of a peripheral usage counter PCNT[i], a noise/spike counter NCNT, at least one glitch counter GCNT[j], a reset counter RCNT, a battery monitor BTM. These counters can be reset via a signal RST_CNT delivered by the finite state machine FSM.

The peripheral usage counter PCNT[i] may be one of a plurality of peripheral usage counters PCNT[0], . . . , PCNT[Np] configured to count the number of usages of the peripherals of the system on chip. In particular, the counters PCNT[0], . . . , PCNT[i], . . . , PCNT[Np] receive respectively signals P_SEL[0], . . . , P_SEL[i], . . . , P_SEL[Np]. Signals P_SEL[0], . . . , P_SEL[i], . . . , P_SEL[Np] that indicate when a peripheral or a group of peripherals is used. The peripheral usage counter(s) PCNT[0], . . . , PCNT[i], . . . , PCNT[Np] can be initialized by the finite state machine FSM with the parameters stored in the non-volatile configuration register NVCR. The peripheral usage counter(s) PCNT[0], . . . , PCNT[i], . . . , PCNT[Np] can be initialized to the maximum value MAX_NB defined by these parameters via the bus PRST_BUS. In this case, a peripheral usage counter is configured to decrement its value by one at each usage of the peripherals. Thus, a peripheral usage counter reaching a zero value indicates an anomalous behavior of the system on chip.

The noise/spike counter NCNT is connected to the Vdd detector watchdog VDD_WTCH of the noise detector NDET to receive noise detection signals NDETS. More particularly, the noise/spike counter NCNT can be initialized by the finite state machine FSM with the parameters stored in the non-volatile configuration register NVCR. The noise/spike counter can be initialized to the maximum value MAX_NB defined by these parameters. In this case, the noise/spike counter is configured to decrement its value by one at each reception of a noise detection signal NDETS from the VDD detector watchdog. Thus, the noise/spike counter reaching a zero value indicates an anomalous behavior of the system on chip SOC.

The at least one glitch counter GNCT[j] is connected to the respective at least one glitch detectors GDET of the noise detector NDET to receive respective glitch detection signals GDETS. The glitch counters GCNT[0], . . . , GCNT[Ng] are configured to count the number of glitches in the Input/Output lines or on the reset signal. More particularly, the glitch counters GCNT[0], . . . , GCNT[Ng] can be initialized by the finite state machine by using the value of the parameters stored in the non-volatile configuration register NVCR. The glitch counters GCNT[0], . . . , GCNT[Ng] can be initialized to the maximum value defined by these parameters. In this case, the glitch counters are configured to decrement their values by one at each reception of a glitch detection signal from the glitch detectors. Thus, a glitch counter reaching a zero value indicates an anomalous behavior of the system on chip SOC.

The reset counter RCNT is configured to count the number of resets of the system on chip in a duration defined by the timer TMR[k]. The reset counter RCNT receives a signal INCR_ON_RST and a signal TIMER_RST. The reset counter RCNT is configured to increment its value by one when a reset occurs. The battery monitor BTM is used to detect a removal of the battery supply of the system on chip and receives a signal SET_FLAG. In particular, if the battery is removed, the value of the VBAT_OK flag is modified. Thus, it is possible to detect that the battery has been removed when the value of the VBAT_OK flag is not the one expected.

Finally, the data monitor DTM ensures the integrity of the data stored. The DATA_OK flag is used to prevent data corruption attack.

The finite state machine FSM of the monitoring circuit MINI is configured to read the values of the different elements of the event counter unit ECU and to compare these values with the value of the parameters stored in the non-volatile configuration register NVCR.

The finite state machine FSM is configured to raise an interruption when a counter of the event counter unit ECU has reached during said duration the maximum value defined by the parameters stored in the non-volatile configuration register NVCR.

More particularly, the finite state machine FSM is configured to first check the value of VBAT_FLAG so as to know whether the battery has been removed.

If the battery has been removed, the finite state machine is configured to disable all the peripherals, to raise an interruption INT and to indicate via the EVENT_BUS signal that the battery has been removed.

If the battery has not been removed, the finite state machine FSM is configured to check the value of the DATA_OK flag so as to know whether the data of the system on chip are corrupt.

If the value of the DATA_OK flag indicates that the data have not been corrupted, the finite state machine FSM is configured to read the parameters in the non-volatile configuration register NVCR.

The finite state machine is configured to initialize the value of the counters of the event counter unit ECU according to the value of the parameters stored in the non-volatile configuration register NVCR through the signal PRESET_BUS.

The finite state machine is also configured to initialize the look-up table of the peripheral management decoder of the peripheral domain by means of the signal LT_CONF with the run mode indicated by the non-volatile configuration register NVCR.

Then, the finite state machine monitors the behavior of the system on chip based on the counter values of the event counter unit ECU. If a counter of the event counter unit ECU reaches the maximum value defined by the parameters of the non-volatile configuration register NVCR, the finite state machine FSM disables the peripherals via signal PR_SEL_PERIPH[i], raises an interruption INT and indicates that an exception occurred via the signal EVENT_BUS.

More particularly, the peripheral disable signal PR_SEL_PERIPH[i] is transmitted to the peripherals.

FIG. 6 shows the peripheral management decoder PMD in more detail. The peripheral management decoder PMD comprises a primary decoder PDEC configured to determine whether one of the peripherals in the peripheral domain can be used to execute an instruction received from the bus matrix BM. The primary decoder PDEC delivers a signal PDEC_SEL[i] indicating which peripheral of the domain has been selected to execute the instruction.

The peripheral management decoder also comprises a look-up table LT. This look-up table LT can be configured by using the signal LT_CONF delivered by the monitoring circuit MM.

The look-up table LT is configured to select a mode register RM[0], . . . , RM[Nr] according to the selected peripheral PDEC_SEL[i]. In particular, the look-up table LT uses signals EN_RM[0], EN_RM[Nr] to select the mode register RM[0], . . . , RM[Nr].

Each mode register RM[0], . . . , RM[Nr] comprises the run mode defined in the non-volatile configuration register NVCR for the selected peripheral.

The peripheral management decoder is configured to determine the run mode of the instruction received by using a run mode determination circuit RMDC. The run mode determination circuit can be a combinatorial network.

The peripheral management decoder comprises comparison means CM configured to determine whether the run mode of the instruction is equal to the run mode defined in the register mode RM[0], . . . , RM[Nr] selected by the look-up table LT.

The comparison means CM are configured to deliver a signal MD_SEL[i] based on the result of the comparison and on the signal PR_SEL_PERIPH[i]. The signal MD_SEL[i] is used to confirm the peripheral selection performed by the primary decoder PDEC.

More particularly, if the run mode is equal to the run mode defined in the non-volatile configuration register NVCR and in the selected mode register mode RM[0], . . . , RM[Nr], it means that the rules defined by the parameters in the non-volatile configuration register applies. In this case, the signal PR_SEL_PERIPH[i] used to manage the peripherals has to be taken into account to determine whether the peripheral can be selected.

This allows a peripheral or a group of peripherals to be disabled when an anomalous behavior of the system on chip is detected by the monitoring circuit.

In particular, the signal MD_SEL[i] is received at an input of a AND logic gate ANDG that also received the signal PDEC_SEL[i] at another input. The AND logic gate ANDG is configured to deliver the signal P_SEL[i].

Thus, by monitoring the behavior of the system on chip, such system on chip is configured to detect an attempted attack on the system on chip by an unauthorized external user.

In particular, the system on chip is configured to detect that an unauthorized external user tries to access the system on chip through multiple and repeated uses of the peripherals of the system on chip or by injecting noise signals or glitches, for example into the power supply voltage of the system on chip. The system on chip is also configured to detect that an unauthorized external user performs a battery removal attack on the system on chip.

When the monitoring circuit detects an attempted attack, the monitoring circuit generates an interrupt signal. This interrupt signal can be transmitted to a master of the system on chip so as to execute an appropriate countermeasure to block the attack.

The countermeasures can be adding delay and/or disabling peripherals of the system on chip (as described above) and/or disabling features of the system on chip.

This allows the security level of the system on chip itself and therefore, for example, the level of protection of the data stored in it and in an electronic device in which the system on chip can be incorporated.

1. A system on a chip, comprising:
a monitoring circuit configured to detect an anomalous behavior of the system on chip, wherein the monitoring circuit operates to:
compare behavior of the system on chip to at least one reference parameter representing the anomalous behavior of the system in order to detect said anomalous behavior of the system on chip; and
generate an interrupt when the anomalous behavior of the system on chip is detected.

2. The system on a chip according to claim 1, configured to be coupled to at least one peripheral, and wherein the monitoring circuit is configured to monitor a usage frequency of said at least one peripheral and to detect the anomalous behavior of the system on chip when the usage frequency of said at least one peripheral reaches a maximum usage frequency value defined by said at least one reference parameter.

3. The system on a chip according to claim 2, wherein the monitoring circuit is further configured to disable said at least one peripheral when the monitoring circuit detects the anomalous behavior of the system on chip.

4. The system on a chip according to claim 2, wherein the monitoring circuit comprises a counter configured to count a number of uses of the at least one peripheral during a period defined by a timer, and to detect the anomalous behavior of the system on chip when the number of the uses counted reaches the maximum usage frequency value defined by the reference parameter representing the anomalous behavior of the system on chip.

5. The system on a chip according to claim 1, wherein the monitoring circuit is configured to monitor a reset cycle frequency of the system on chip and to detect the anomalous behavior of the system on chip when the reset cycle frequency reaches a maximum reset cycle frequency value defined by said at least one reference parameter.

6. The system on a chip according to claim 5, wherein the monitoring circuit comprises a counter configured to count a number of system on chip resets during a period defined by a timer, and to detect the anomalous behavior of the system on chip when the number of the system on chip resets counted reaches the maximum reset cycle frequency value defined by the reference parameter representing the anomalous behavior of the system on chip.

7. The system on a chip according to claim 1, wherein the monitoring circuit is powered from a supply voltage and is configured to monitor a frequency of supply voltage spikes and to detect the anomalous behavior of the system on chip when the frequency of supply voltage spikes reaches a maximum spike frequency value defined by said at least one reference parameter.

8. The system on a chip according to claim 7, wherein the monitoring circuit comprises a counter configured to count a number of supply voltage spikes during a period defined by a timer, and to detect the anomalous behavior of the system on chip when the number of the supply voltage spikes counted reaches the maximum spike frequency value defined by the reference parameter representing the anomalous behavior of the system on chip.

9. The system on a chip according to claim 1, wherein the monitoring circuit is configured to process Input/Output signals and monitor a frequency of glitches in the Input/Output signals to detect the anomalous behavior of the system on chip when the frequency of glitches reaches a maximum glitch frequency value defined by said at least one reference parameter.

10. The system on a chip according to claim 9, wherein the monitoring circuit comprises a counter configured to count a number of glitches in the Input/Output signals during a period defined by a timer, and to detect the anomalous behavior of the system on chip when the number of the glitches counted reaches the maximum glitch frequency value defined by the reference parameter representing the anomalous behavior of the system on chip.

11. The system on a chip according to claim 1, wherein the monitoring circuit is configured to detect a removal of a battery of the system on chip and generate the interrupt in response to the detection.

12. The system on a chip according to claim 1, wherein said at least one reference parameter is stored in a non-volatile register.

13. A method for detecting an anomalous behavior of a system on a chip, comprising:
comparing behavior of the system on chip to at least one reference parameter representing the anomalous behavior of the system in order to detect said anomalous behavior of the system on chip; and
generating an interrupt when the anomalous behavior of the system on chip is detected.

14. The method according to claim 13, wherein the system on chip is coupled to at least one peripheral, and comparing comprises:
monitoring a usage frequency of said at least one peripheral; and
detecting the anomalous behavior of the system on chip when the usage frequency of said at least one peripheral reaches a maximum usage frequency value defined by said at least one reference parameter.

15. The method according to claim 14, further comprising disabling said at least one peripheral when the anomalous behavior of the system on chip is detected.

16. The method according to claim 14, wherein monitoring comprises counting a number of uses of the at least one peripheral during a period defined by a timer of the system on chip, and wherein detecting comprises identifying when the counted number of uses reaches the maximum usage frequency value.

17. The method according to claim 13, wherein comparing comprises:
monitoring a reset cycle frequency of the system on chip; and
detecting the anomalous behavior of the system on chip when the reset cycle frequency reaches a maximum reset cycle frequency value defined by said at least one reference parameter.

18. The method according to claim 17, wherein monitoring comprises counting a number of resets during a period defined by a timer of the system on chip, and wherein detecting comprises identifying when the counted number of resets reaches the maximum reset cycle frequency value.

19. The method according to claim 13, wherein comparing comprises:
monitoring a supply voltage spike frequency; and
detecting the anomalous behavior of the system on chip when the spike frequency reaches a maximum spike frequency value defined by said at least one reference parameter.

20. The method according to claim 19, wherein monitoring comprises counting a number of spikes in supply voltage during a period defined by a timer of the system on chip, and wherein detecting comprises identifying when the counted number of spikes reaches the maximum spike frequency value.

21. The method according to claim 13, wherein comparing comprises:
monitoring an Input/Output signal glitch frequency; and
detecting the anomalous behavior of the system on chip when the Input/Output signal glitch frequency reaches a maximum glitch frequency value defined by said at least one reference parameter.

22. The method according to claim 21, wherein monitoring comprises counting a number of glitches in the Input/Output signals during a period defined by a timer of the system on chip, and wherein detecting comprises identifying when the counted number of glitches reaches the maximum glitch frequency value.

23. The method according to claim 13, wherein comparing comprises detecting a removal of a battery of the system on chip.
